(19) United States
(12) Patent Application Publication
(10) Pub. No.: US 2021/0183307 A1
(43) Pub. Date: Jun. 17, 2021

(54) EIGHT TRANSISTOR/1 CAPACITOR OLED CIRCUITS

(71) Applicant: Hewlett-Packard Development Company, L.P., Spring, TX (US)

(72) Inventors: Hsing-Hung Hsieh, Taipei (TW); Super Liao, Taipei (TW); Ann Alejandro Villegas, Spring, TX (US)

(73) Assignee: Hewlett-Packard Development Company, L.P., Spring, TX (US)

(21) Appl. No.: 17/048,764

(22) PCT Filed: Sep. 5, 2018
(86) PCT No.: PCT/US2018/049475

§ 371 Date: Oct. 19, 2020

(51) Int. Cl. G09G 3/3225

(52) U.S. Cl. CPC G09G 3/3225; G09G 2320/046; G09G 2300/0842; G09G 2300/0819

(57) ABSTRACT

An organic light-emitting diode (OLED) circuit that includes a first, second, third, fourth, fifth, sixth, seventh, and eighth transistor; a capacitor; a first select line, a second select line, and a third select line; and a data line; wherein the consecutive selection of the first select line, second select line, and third select line compensates for a threshold voltage in the second transistor.

### BACKGROUND

Organic light-emitting diodes (OLEDs) are used to form displays in electronic devices. OLED displays, as compared to light emitting diode (LED) displays, may be relatively thinner and lighter, have a relatively faster response time, include a relatively higher contrast ration, and include a larger color gamut.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a circuit diagram of an organic light-emitting diode (OLED) circuit according to an example of the principles described herein.

FIG. 2 is a driving waveform chart showing the activation of the first select line, second select line, third select line, and/or data line over time according to an example of the principles described herein.

FIG. 3 is a flowchart showing a method of actuating an organic light-emitting diode (OLED) according to an example of the principles described herein.

FIG. 4 is a block diagram of a display device according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

OLED display devices implement a number of OLEDs that, together, display an image to a user. The OLEDs may each be a light-emitting diode (LED) in which an emissive electroluminescent layer of an organic compound that, in response to excitation from an electric current, emits light. In some OLED displays, each pixel may include an OLED electrically connected to a circuit used to drive that OLED.

The circuit may be, in an example, a two-transistor/1 capacitor (2T1C) circuit. Each OLED pixel circuit may include two transistors and 1 capacitor, which connect to 1 scan line, 1 data line, 1 high voltage power line (V_{dd}), and 1 low voltage power line (Vₛₛ). This circuitry activates the OLED by electrically connecting a data line to a first terminal of a switching transistor with a second terminal of the switching transistor being connected to a driving transistor. The driving transistor is therefore activated according to the signal from date line. The luminance of the OLED is proportional to the current of the driving transistor; the transistor connected to the OLED. The current equation at the driving transistor may be as follows:

$${I}_{D} = \frac{μ {C}_{ox}}{2} \frac{W}{L} ( {V}_{GS} - {V}_{th} )$$

However, due to use of the display, the transistor may degrade over time. Because the threshold voltage (Vₜₕ) affects the current provided to the OLED, any variations in the characteristics of the transistor and the Vₜₕ shift after operation may cause image sticking. Phenomenon such as image sticking, burn-in, or transient image persistence may be seen by a user as the driving transistor begins to degrade and the threshold voltage (Vₜₕ) is increased. This may result in once white areas appearing as black images even when an image is not being presented. As a consequence, image quality is degraded and viewer satisfaction is reduced.

The present specification describes an organic light-emitting diode (OLED) circuit that includes a first, second, third, fourth, fifth, sixth, seventh, and eighth transistor; a capacitor; a first select line, a second select line, and a third select line; and a data line; wherein the consecutive selection of the first select line, second select line, and third select line compensates for a threshold voltage in the second transistor.

The present specification also describes a method of actuating an organic light-emitting diode (OLED) that includes with an organic light-emitting diode (OLED) electrically connected to an eight transistors/1 capacitor circuit (8T1C) comprising a first, second, third, fourth, fifth, sixth, seventh, and eighth transistor and a first, second and third select line: compensating for a variable threshold of the second transistor by activating the second select line to set a first terminal of the capacitor and a first terminal on the second transistor to V_{dd}, setting a third terminal of the second transistor to V_{dd} minus the threshold voltage of the second transistor, setting a first terminal of the OLED and a third terminal of the seventh transistor to Vₛₛ plus VOLED, and setting a second terminal of the capacitor to Vₛₛ activating a data line and the first select line to set the first terminal of the capacitor to V_{dd}+(V_{data}−Vₛₛ), set a first terminal of the OLED to Vss, and setting a second terminal of the capacitor to Vdata; and activating the third select line connected to a first terminal of the seventh transistor to activate the OLED electrically connected to a third terminal of the seventh transistor.

The present specification further describes a display device that includes a plurality of pixels, each pixel comprising a plurality of organic light-emitting diodes (OLEDs), wherein each OLED is electrically connected to a pixel circuit comprising: a first, second, third, fourth, fifth, sixth, seventh, and eighth transistor; a capacitor; a first select line, a second select line, and a third select line; and a data line; wherein the consecutive selection of the first select line, second select line, and third select line compensates for a threshold voltage of the second transistor.

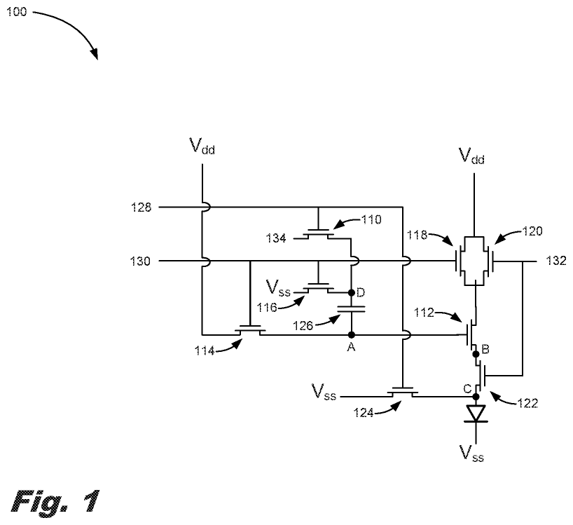

Turning now to the figures, FIG. 1 is a circuit diagram of an organic light-emitting diode (OLED) circuit (100) according to an example of the principles described herein. The OLED circuit (100) may be an eight transistors/one capacitor (8T1C) as shown. Arrangement of these transistors and capacitor relative to the OLED (105) allows for the compensation of the degradation of the driving transistor that results in a variable threshold voltage (Vₜₕ) in that transistor.

The OLED circuit (100) includes a first transistor (110), a second transistor (112), a third transistor (114), a fourth transistor (116), a fifth transistor (118), a sixth transistor (120), a seventh transistor (122), an eight transistor (124), and a capacitor (126). The OLED circuit (100) also includes a first select line (128), a second select line (130), a third select line (132), and a data line (134). In reference to the operation of the OLED circuit (100), the transistors (110, 112, 114, 116, 118, 120, 122, 124) and capacitor (126) may be electrically connected to a drain voltage (V_{dd}) and/or a source voltage (Vₛₛ). With regard to the description of operation of the OLED circuit (100), reference will be made to the state at points A, B, C, and D. These points indicated the voltage potential at these points upon activation of the first select line (128), the second select line (130), the third select line (132), and/or data line (134).

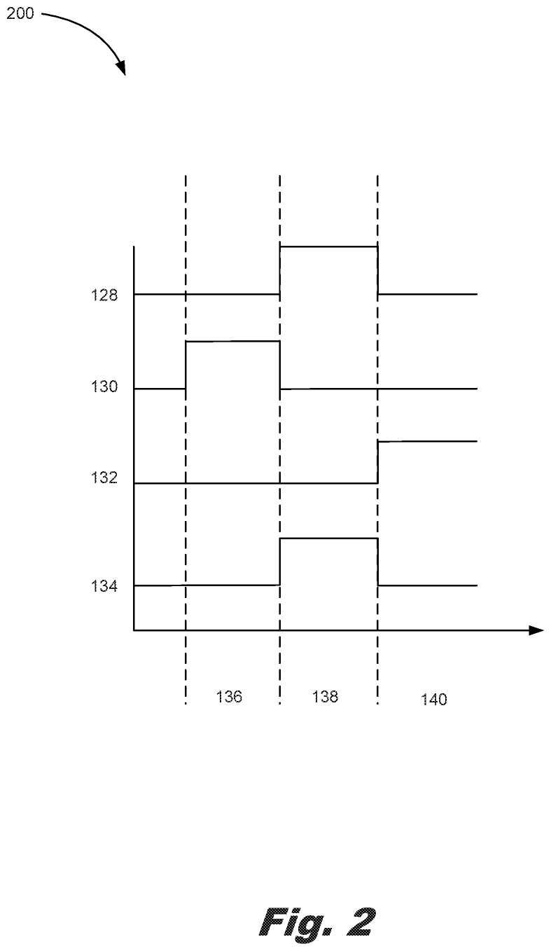

FIG. 2 is a driving waveform chart (200) showing the activation of the first select line (128), second select line (130), third select line (132), and/or data line (134) over time according to an example of the principles described herein. The vertical axis indicates the signal from the first select line (128), the second select line (130), the third select line (132), and/or data line (134) as described herein. The horizontal axis indicates the flow of time as well as the states of the OLED circuit (100): either on or off. In this example, the states may include a compensation state (136), a data input state (138), and an OLED emission state (140). FIGS. 1 and 2 will be described in connection with each other to describe the operation of the OLED circuit (100).

During operation of the OLED circuit (100), the compensation state (136) may be initiated by setting point A to a charge equal to V_{dd} via the third transistor (114) and the second transistor (112). This is done by activating the second select line (130). Point A is a point where a third terminal of the third transistor (114), a first terminal of the second transistor (112), and a first terminal of the capacitor (126) are connected. As used in the present specification, a first terminal of an of the transistors (110, 112, 114, 116, 118, 120, 122, 124) may be a gate, a second terminal of the transistors (110, 112, 114, 116, 118, 120, 122, 124) may be a source, and a third terminal of the transistors (110, 112, 114, 116, 118, 120, 122, 124) may be the drain. In some examples, however, the source and drain terminals may be switched and the present specification contemplates such a circuit.

Additionally, activation of the second select line (130) causes the charge at point B to be V_{dd}−Vₜₕ (voltage threshold of the driving transistor, the second transistor (112)). Point B is the connection between the second terminal of the second transistor (112) and the third terminal of the seventh transistor (122). Further, activation of the second select line (130) causes the charge at point C to be V_{OLED}+Vₛₛ. Even further, activation of the second select line (130) causes the charge at point D to be Vₛₛ. Point D is the connection between a third terminal of the fourth transistor (116), a second terminal of the capacitor (126), and a third terminal of the first transistor (110). Activation of the second select line (130) in this way records the Vₜₕ of the driving transistor, in this example second transistor (112), to the capacitor (126) in order to later compensate for the Vₜₕ that may change over time during the operating lifetime of the OLED circuit (100), the OLED itself, and/or a display device incorporating the OLED and OLED circuit (100).

During operation and after the compensation state (136) has been initiated, a data input state (138) may be initiated. In this example, the data input state (138) includes the activation of the data line (134) and the first select line (128). Upon activation of the data line (134) and first select line (128), the charge present at points A, B, C, and D may change. At point A, the charge has changed to V_{dd}+(V_{data}−Vₛₛ). At point B, the charge remains at V_{dd}−Vₜₕ. At point C, the charge has been changed from V_{OLED}+Vₛₛ to Vₛₛ. The charge at point D has changes from Vₛₛ to V_{data}. During this data input state (138), the threshold voltage of the second transistor (112) has been compensated for by altering the current passed through the second transistor (112).

During operation and after the initiating of the data input state (138), the OLED circuit (100) may initiate an OLED emission state (140). The OLED emission state (140) includes the activation of the third select line (132). Activation of the third select line (132) causes the current (V_{dd}) to flow to the OLED via the sixth transistor (120), the second transistor (112), and the seventh transistor (122). Accordingly, the Vₜₕ effects of the second transistor (112) is eliminated according to the following equation:

$${I}_{D} = \frac{μ {C}_{ox}}{2} \frac{W}{L} ( {V}_{SS} - {V}_{th} ) = \frac{μ {C}_{ox}}{2} \frac{W}{L} ( {V}_{data} - {V}_{ss} )$$

In any example presented herein, the compensation state (136), the data input state (138), and the OLED emission state (140) may be completed any number of times. In an example, where a display device operates at 60 Hz, the activation of the compensation state (136), the data input state (138), and the OLED emission state (140) is accomplished 60 times per second for each OLED present in the display device. In any example presented herein, each pixel of the display device may include a plurality of OLEDs each forming a sub-pixel. In this example, the plurality of OLEDs may be of a different color such as red, green, and blue. In this example, a combination of the three colors or activation of the three distinct OLEDs results in a white color being presented. It is each of these three OLEDs representing three sub-pixels within a given pixel of the display that has an associated OLED circuit (100).

In any example presented herein, the ratio of the channel width to the channel length of the second transistor (112) may be different from other transistors (110, 114, 116, 118, 120, 122, 124) in the OLED circuit (100). In an example, the ratio of the channel width to the channel length (W/L) of the second transistor (112) is smaller than the W/L of the sixth transistor (120) and/or seventh transistor (122). By forming the W/L of the second transistor (112) smaller than the W/L of either of the sixth transistor (120) or seventh transistor (122), the current that is to flow through OLED is thus decided by the second transistor. Since the luminance of an OLED is proportional to the current that flows through it, the luminance, in this example circuit, may be decided by the second transistor. As a result, the circuit describe herein eliminates the threshold voltage effects of the second transistor and, consequently, the image quality is improved by preventing image sticking.

Although the present specification and claims show a specific layout and electrical coupling of any of the transistors (110, 112, 114, 116, 118, 120, 122, 124) and capacitor (126), the present specification contemplates the arrangement of the transistors (110, 112, 114, 116, 118, 120, 122, 124) and capacitor (126) to accomplish the activation of the OLED after compensating for the changing Vₜₕ of the driving transistor such as the second transistor (112).

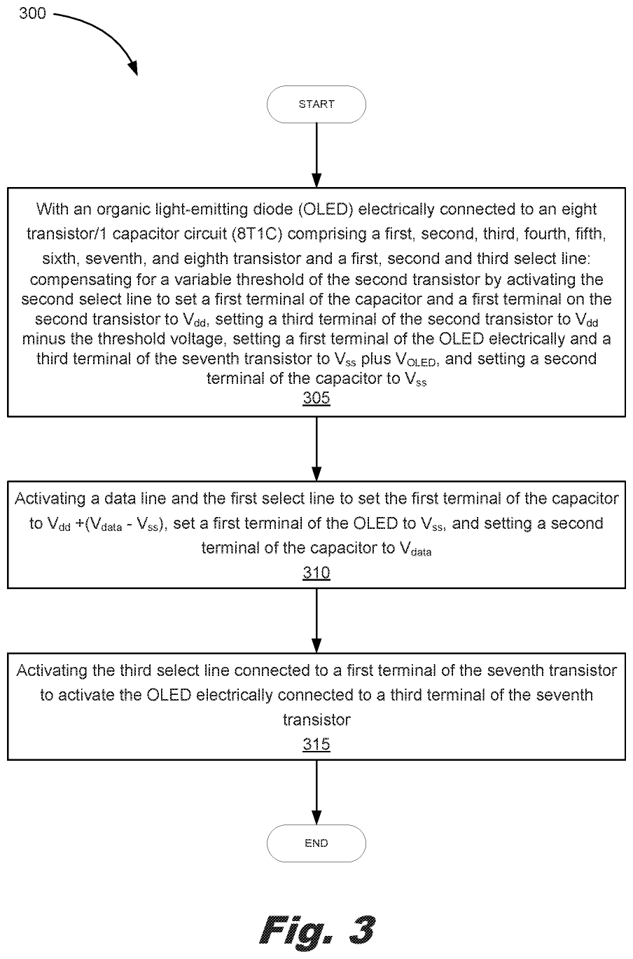

FIG. 3 is a flowchart showing a method (300) of actuating an organic light-emitting diode (OLED) according to an example of the principles described herein. The method (300) may start with compensating (305) for a variable threshold of the second transistor by activating the second select line to set a first terminal of the capacitor and a first terminal on the second transistor to V_{dd}, setting a third terminal of the second transistor to V_{dd} minus the threshold voltage, setting a first terminal of the OLED electrically and a third terminal of the seventh transistor to Vₛₛ plus V_{OLED}, and setting a second terminal of the capacitor to Vₛₛ.

The method (300) may continue with activating (310) a data line and the first select line to set the first terminal of the capacitor to V_{dd}+(V_{data}−Vₛₛ), set a first terminal of the OLED to Vₛₛ, and setting a second terminal of the capacitor to V_{data}.

The method may continue with activating (315) the third select line connected to a first terminal of the seventh transistor to activate the OLED electrically connected to a third terminal of the seventh transistor.

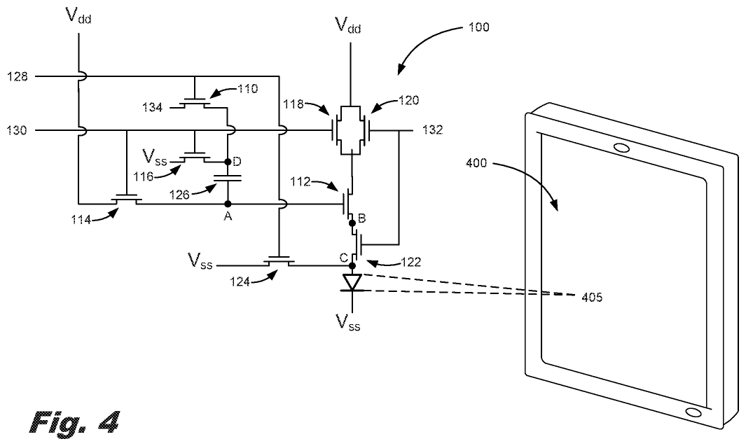

FIG. 4 is a block diagram of a display device (400) according to an example of the principles described herein. The display device (400) may include any number of pixels (405) that may include any number of OLED circuits (100). Indeed, as described herein, each pixel (405) may include any number of sub-pixels used to increase the gamut capabilities of the display device (400). In the example presented in FIG. 4, the OLED circuit (100) may be associated with a red OLED, a green OLED, or a blue OLED. Thus, although FIG. 4 shows a single pixel having a single OLED circuit (100) associated therewith, the present specification contemplates that a plurality of OLED circuits (100) may be associated with any given pixel (405).

As described herein, each OLED circuit (100) associated with each pixel (405) of the display device (400) may be operated according to that described in connection with FIGS. 1-3. In particular, each of the OLED circuits (100) may initiate a compensation state (136), a data input state (138), and an OLED emission state (140) in order to compensate for the Vₜₕ of the second transistor (112). In an example, during selection of the second select line (130), a threshold voltage of the second transistor (112) is stored at a third terminal of a second transistor and a first terminal of the capacitor (126). In an example, the consecutive selection of the first select line (128) and the third select line (132) provides a current which is independent to the Vₜₕ of the second transistor (112) to each OLED.

The OLED circuit (100) shown in FIG. 1 and FIG. 4 eliminates the Vₜₕ variation or shift of the driving transistor of the OLED. Consequently, the driving current presented to the OLED is kept independent of the Vₜₕ of the second transistor (112). This, in turn, prevents transient image persistence on the OLED-based display device. As a consequence, the visual accuracy of the display may be preserved increasing user satisfaction of viewing by maintaining the contrast ratio of colors as well as the gamut presented on the display.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, the processor of a computing device associated with the display device or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The preceding description has been presented to illustrate and describe examples of the principles described. This description is not intended to be exhaustive or to limit these principles to any precise form disclosed. Many modifications and variations are possible in light of the above teaching.

What is claimed is:

1. An organic light-emitting diode (OLED) circuit, comprising:
a first, second, third, fourth, fifth, sixth, seventh, and eighth transistor;
a capacitor;
a first select line, a second select line, and a third select line; and
a data line;
wherein the consecutive selection of the first select line, second select line, and third select line compensates for a threshold voltage in the second transistor.

2. The OLED circuit of claim 1, wherein selection of the second select line causes a first terminal of the capacitor to be charged to V_{dd}, sets a charge between a second terminal of the capacitor and a third terminal of the fourth transistor to Vₛₛ, sets a charge between a third terminal of the second transistor and a second terminal of the seventh transistor to V_{dd} minus a threshold voltage of the second transistor.

3. The OLED circuit of claim 2, wherein the selection of the second select line constitutes a compensation stage of the circuit.

4. The OLED circuit of claim 1, wherein selection of the first select line sets a charge between a second terminal of the capacitor and a first terminal of the fourth transistor to V_{data} while the first terminal of the capacitor is coupled with the voltage of V_{dd}+(V_{data}−Vₛₛ), and sets a charge between a third terminal of the second transistor and a second terminal of the seventh transistor to V_{dd} minus a threshold voltage of the second transistor.

5. The OLED circuit of claim 4, wherein the selection of the first select line and a data line constitutes a data input stage of the circuit.

6. The OLED circuit of claim 1, selection of the third select line sets, after selection of the first and second lines, a charge between a third terminal of the second transistor and a second terminal of the seventh transistor to V_{dd} minus a threshold voltage of the second transistor.

7. The OLED circuit of claim 6, comprising an OLED electrically connected to the seventh transistor to receive the voltage or current from the seventh transistor during selection of the third select line.

8. The OLED circuit of claim 1, wherein a ratio of the channel width to the channel length (W/L) of the second transistor is smaller than a ratio of the channel width to the channel length (W/L) of the sixth and seventh transistor.

9. The OLED circuit of claim 1, wherein:
the first transistor comprises a first terminal electrically connected to the first select line, a second terminal electrically connected to the data line, and a third terminal electrically connected to a third terminal of the fourth transistor and a second terminal of the capacitor;
the fourth transistor comprises a first terminal electrically connected to the second select line, a second terminal electrically connected to Vₛₛ, and a third terminal electrically connected to the third terminal of the first transistor and the second terminal of the capacitor;
the third transistor comprises a first terminal electrically connected to the second select line, a second terminal electrically connected to V_{dd}, and a third terminal electrically connected to a first terminal of the capacitor;
the eight transistor comprises a first terminal electrically connected to the first select line, a second terminal electrically connected to Vₛₛ, and a third terminal electrically connected to a first terminal of an organic light emitting diode (OLED);
the fifth transistor comprises a first terminal electrically connected to the second select line, a second terminal electrically connected to a second terminal of the sixth transistor and V_{dd}, and a third terminal electrically connected to a third terminal of the sixth transistor and a second terminal of the second transistor;
the sixth transistor comprises a first terminal electrically connected to the third select line, a second terminal electrically connected to a second terminal of the fifth transistor and V_{dd}, and a third terminal electrically connected to a third terminal of the fifth transistor and a second terminal of the second transistor;
the second transistor comprises a first terminal electrically connected to the first terminal of the capacitor and the third terminal of the third transistor, a second terminal electrically connected to a third terminal of the fifth transistor and a third terminal of the sixth transistor, and a third terminal electrically connected to a second terminal of the seventh transistor;
the seventh transistor comprises a first terminal electrically connected to the third select line, a second terminal electrically connected to the third terminal of the second transistor, and a third terminal electrically connected to the first terminal of the OLED.

10. A method of actuating an organic light-emitting diode (OLED), comprising:
with an organic light-emitting diode (OLED) electrically connected to an eight transistors/1 capacitor circuit (8T1C) comprising a first, second, third, fourth, fifth, sixth, seventh, and eighth transistor and a first, second and third select line:
compensating for a variable threshold of the second transistor by activating the second select line to set a first terminal of the capacitor and a first terminal on the second transistor to V_{dd}, setting a third terminal of the second transistor to V_{dd} minus the threshold voltage of the second transistor, setting a first terminal of the OLED electrically and a third terminal of the seventh transistor to Vₛₛ plus V_{OLED}, and setting a second terminal of the capacitor to Vₛₛ;
activating a data line and the first select line to set the first terminal of the capacitor to V_{dd}+(V_{data}−Vₛₛ), set a first terminal of the OLED to Vₛₛ, and setting a second terminal of the capacitor to V_{data}; and
activating the third select line connected to a first terminal of the seventh transistor to activate the OLED electrically connected to a third terminal of the seventh transistor.

11. The method of claim 10, wherein a second terminal of the sixth transistor is electrically connected to V_{dd}, a third terminal of the sixth transistor is electrically connected to a second terminal of the second transistor.

12. A display device, comprising:
a plurality of pixels, each pixel comprising a plurality of organic light-emitting diodes (OLEDs), wherein each OLED is electrically connected to a pixel circuit comprising:
a first, second, third, fourth, fifth, sixth, seventh, and eighth transistor;
a capacitor;
a first select line, a second select line, and a third select line; and
a data line;
wherein the consecutive selection of the first select line, second select line, and third select line compensates for a threshold voltage of the second transistor.

13. The display device of claim 12, wherein during selection of the second select line, a threshold voltage of the second transistor is stored at the third terminal of the second transistor and a first terminal of the capacitor.

14. The display device of claim 12, wherein consecutive selection of the first select line and the third select line provides a current which is independent to the threshold voltage of the second transistor associated with each OLED.

15. The display device of claim 12, wherein a ratio of a channel width to a channel length (W/L) of the second transistor is smaller than a ratio of a channel width to a channel length (W/L) of the sixth and seventh transistor.
